(19) United States
(12) Patent Application Publication
(10) Pub. No.: US 2025/0210805 A1
(43) Pub. Date: Jun. 26, 2025

(54) BATTERY PACK

(71) Applicant: TOYOTA JIDOSHA KABUSHIKI KAISHA, Toyota-shi Aichi-ken (JP)

(72) Inventors: Shinya GOITSUKA, Nisshin-shi Aichi-ken (JP); Shigeyuki INOUE, Toyota-shi Aichi-ken (JP)

(73) Assignee: TOYOTA JIDOSHA KABUSHIKI KAISHA, Toyota-shi Aichi-ken (JP)

(21) Appl. No.: 18/986,938

(22) Filed: Dec. 19, 2024

(30) Foreign Application Priority Data
Dec. 26, 2023 (JP) 2023-218840

(51) Int. Cl. H01M 50/383

(52) U.S. Cl. CPC H01M 50/383

(57) ABSTRACT

Provided is a battery pack for further suppressing thermal influence of discharged gas on the wire harness. The battery pack according to the present disclosure is provided with a battery module having a smoke exhaust structure, and includes a lower mica sheet mounted on an upper surface of the battery module, a wire harness mounted on an upper surface of the lower mica sheet, and an upper mica sheet mounted on an upper surface of the wire harness, in which an inside of the battery pack of the wire harness is covered with at least one of the upper mica sheet and the lower mica sheet.

### CROSS REFERENCE TO RELATED APPLICATIONS

This application is based upon and claims the benefit of priority from Japanese patent application No. 2023-218840, filed on Dec. 26, 2023, the disclosure of which is incorporated herein in its entirety by reference.

### BACKGROUND

The present disclosure relates to a battery pack.

In battery pack provided with battery module, a technology for protecting battery module by mica sheet is known.

For example, Patent Document 1 discloses a battery pack having a plurality of mica sheet for covering electrode terminals and bus bars.

Patent Literature 1: Japanese Unexamined Patent Application Publication No. 2023-046898

### SUMMARY

The inventors have found the following problems with a battery pack.

When a smoke exhaust structure is provided in a battery module, there is a possibility that the surrounding members are affected by the discharged gas. Therefore, in the technique disclosed in Patent Literature 1, the influence of the discharged gas is suppressed by allowing the discharged gas to flow to the mica sheet side using a smoke exhaust cover. A voltage/temperature detection line, i.e., a wire harness, attached to a battery module is sometimes arranged in a path of the discharged gas. In this case, the wire harness is susceptible to the thermal influence of the discharged gas. Therefore, there has been a need for a technology for further suppressing the thermal influence of the discharged gas on the wire harness.

The present disclosure has been made in view of the aforementioned problem and an object of the present disclosure is to provide a battery pack for further suppressing the thermal influence of the discharged gas on a wire harness.

An aspect for achieving the above object is a battery pack provided with a battery module having a smoke exhaust structure, including:
a lower mica sheet mounted on an upper surface of the battery module;
a wire harness mounted on an upper surface of the lower mica sheet; and
an upper mica sheet mounted on an upper surface of the wire harness,
in which an inside of the battery pack of the wire harness is covered with at least one of the upper mica sheet and the lower mica sheet.

According to the present disclosure, it is possible to provide a battery pack which further suppresses the thermal influence of discharged gas on the wire harness.

The above and other objects, features and advantages of the present disclosure will become more fully understood from the detailed description given hereinbelow and the accompanying drawings.

### BRIEF DESCRIPTION OF DRAWINGS

FIG. 1 is a partial perspective schematic view of a battery pack according to an embodiment; and

FIG. 2 is a partial enlarged cross-sectional view taken along the line II-II in FIG. 1.

### DESCRIPTION OF EMBODIMENTS

Hereinafter, an embodiment of the present disclosure will be described in detail with reference to the drawings. In each of the drawings, the same or corresponding elements are denoted by the same reference numerals, and redundant explanations will be omitted as necessary for the sake of clarification. For ease of understanding, the scale of each element illustrated in the drawings may differ from the actual scale.

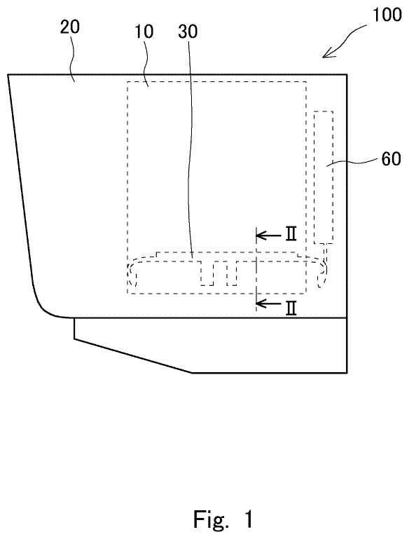

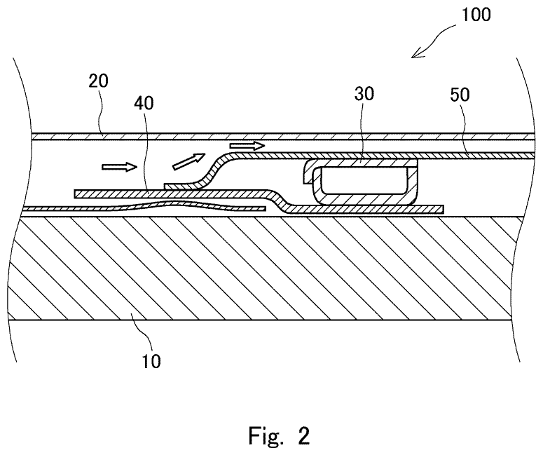

The configuration of a battery pack 100 according to the present embodiment will be described with reference to FIGS. 1 and 2. The battery pack 100 is a battery pack including a smoke exhaust structure. The battery pack 100 is a battery that can be repeatedly charged and discharged, that is, a secondary battery. The battery pack 100 is mounted on a vehicle equipped with a driving motor such as an HEV (Hybrid Electric Vehicle), PHV (Plug-in Hybrid Electric Vehicle), FCV (Fuel Cell Electric Vehicle), EV (Electric Vehicle), and is used as a power supply for supplying electric power for the driving motor.

FIG. 1 is a partial perspective schematic view of a battery pack according to the present embodiment. FIG. 2 is a partial enlarged cross-sectional view taken along the line II-II in FIG. 1. As shown in FIG. 2, the battery pack 100 includes a battery module 10, a housing 20, a wire harness 30, a lower mica sheet 40, and an upper mica sheet 50. As shown in FIG. 1, the battery pack 100 typically further includes an SBM (Satellite Battery Module) 60.

The battery module 10 includes a plurality of battery cells. The housing 20 is a container for storing various components of the battery pack 100. The wire harness 30 is a wire for measuring temperature and pressure. As shown in FIG. 1, the wire harness 30 is provided to connect the battery module 10 and the SBM 60. As shown in FIG. 1, the wire harness 30 is disposed on an upper surface of the battery module 10 and extends along the edge of the battery module 10. The location and the shape of the wire harness 30 shown in FIG. 1 are mere examples, and may be changed as appropriate.

The lower mica sheet 40 is a sheet placed on an upper surface of the battery module 10. The lower mica sheet 40 protects the battery module 10. In FIG. 2, an inside of the battery pack 100 is illustrated on the left-hand side in FIG. 2, and outside of the battery pack 100 is illustrated on the right-hand side in FIG. 2. As shown in FIG. 2, the lower mica sheet 40 may be provided to extend from the inside of the battery pack 100 to the outside of the battery pack 100 of the wire harness 30, for example.

The upper mica sheet 50 is a sheet placed on an upper surface of the wire harness 30. As shown in FIG. 2, the upper mica sheet 50 may be provided so as to protrude from the inside of the battery pack 100 to the outside of the battery pack 100 of the wire harness 30, for example. The lower mica sheet 40 and the upper mica sheet 50 may be provided so as to be aligned inside the battery pack 100, as shown in FIG. 2.

The arrows shown in FIG. 2 indicate the flow of the gas to be discharged. As shown in FIG. 2, the gas flows from the inside to the outside of the battery pack 100. By covering the inside of the battery pack 100 of the wire harness 30 with at least one of the lower mica sheet 40 and the upper mica sheet 50, as shown in FIG. 2, the wire harness 30 is protected from the heat of the gas and debris to be discharged. As shown in FIG. 2, in some embodiments, the inside of the battery pack 100 of the wire harness 30 is not covered with the lower mica sheet 40 and the upper mica sheet 50 from the viewpoint of reducing the amount of mica sheet used.

Since the battery pack 100 protects the wire harness 30 by mica sheet, the occurrence of a short circuit of the wire harness 30 at the time of occurrence of overheating can be suppressed, and the occurrence of chain smoke emission can be suppressed. Since the wire harness 30 is arranged on the battery module 10 of the battery pack 100, the lateral width of the battery pack 100 can be reduced as compared with the case where the wire harness 30 is arranged next to the battery pack 100. Therefore, the energy density of the battery pack 100 is improved, and the competitiveness as a product is improved. Since mica sheet for protecting the wire harness 30 is arranged on the battery module 10 of the battery pack 100, the local input to the battery cell upper surface of the battery module 10 is distributed, and the input resistance to the cell upper surface is improved.

It should be noted that present disclosure is not limited to the above embodiments and may be changed as appropriate to the extent that it does not deviate from the gist of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack provided with a battery module having a smoke exhaust structure, comprising:
a lower mica sheet mounted on an upper surface of the battery module;
a wire harness mounted on an upper surface of the lower mica sheet; and
an upper mica sheet mounted on an upper surface of the wire harness,
wherein an inside of the battery pack of the wire harness is covered with at least one of the upper mica sheet and the lower mica sheet.

2. The battery pack according to claim 1, wherein an outside of the battery pack of the wire harness is not covered with the upper mica sheet and the lower mica sheet.
